(19) United States
(12) Patent Application Publication
(10) Pub. No.: US 2013/0177286 A1
(43) Pub. Date: Jul. 11, 2013

(54) NONINVASIVE ACCURATE AUDIO SYNCHRONIZATION

(71) Applicant: Mozaik Multimedia, Inc, Dover, DE (US)

(72) Inventors: Valentino Miazzo, Macherio (IT); Davide Maestroni, Lainate (IT); Marco Filosi, Usmate Velate (IT); Alberto Congiu, Cagliari (IT)

(73) Assignee: MOZAIK MULTIMEDIA, INC, Dover, DE (US)

(21) Appl. No.: 13/736,731

(22) Filed: Jan. 8, 2013

Related U.S. Application Data
(60) Provisional application No. 61/584,682, filed on Jan. 9, 2012.

(51) Int. Cl. H04N 9/87; G06F 3/16

(52) U.S. Cl. CPC H04N 9/87; G06F 3/16
USPC 386/201; 700/94

(57) ABSTRACT

In various embodiments, a platform is provided for interactive user experiences. An application, running on device A, can be synchronised with the audio reproduced by a device B. Device A can listen to the audio of device B and obtaining the timecode by processing the recorded audio. Therefore, an application, running on a portable device, can display trivia and information exactly at certain points of a show reproduced by a TV set located in the same room.

### CROSS-REFERENCES TO RELATED APPLICATIONS

This Application hereby incorporates by reference for all purposes the following commonly owned and co-pending U.S. Patent Applications:

U.S. patent application No. 12/795,397, filed Jun. 7, 2010 and entitled “Ecosystem For Smart Content Tagging And Interaction” which claims priority to U.S. Provisional Patent Application No. 61/184,714 filed Jun. 5, 2009 and entitled “Ecosystem For Smart Content Tagging And Interaction”; U.S. Provisional Patent Application No. 61/286,791, filed Dec. 16, 2009 and entitled “Personalized Interactive Content System and Method”; and U.S. Provisional Patent Application No. 61/286,787, filed Dec. 19, 2009 and entitled “Personalized and Multiuser Content System and Method”;

U.S. patent application No. 12/471,161 filed May 22, 2009 and entitled “Secure Remote Content Activation and Unlocking”;

U.S. patent application No. 12/485,312, filed Jun. 16, 2009 and entitled “Movie Experience Immersive Customization.”

### BACKGROUND OF THE INVENTION

Advanced set-top boxes, next generation Internet-enabled media players, such as Blu-ray and internet-enabled TVs, bring a new era of entertainment to the living room. In addition to higher quality pictures and a better sound, many devices can be connected to networks, such as the Internet. Furthermore, broadcast programming, home movies, and on-demand programming can be augmented with additional content viewable through the set-top boxes or through companion, devices, such as personal digital assistants (PDAs), laptops, tablets, smartphones, feature phones, or the like.

Frequent problems can arise in the unequal processing of multiple signals (e.g., audio or video) and transmission delays between the origination point of a content source and reception points. Such variable transmission delays between audio and video components of a program, for example, can lead to obvious problems such as the loss of lip synchronization. Further, unequal processing can lead to other annoying discrepancies between the presentation multimedia Information from one source and the presentation of additional or supplemented multimedia information from the same or different sources that need to be synchronized with the first.

Accordingly, what is desired is to solve problems relating to noninvasive accurate synchronization of multimedia information, some of which may be discussed herein. Additionally, what is also desired is to reduce drawbacks related to synchronization of multimedia information, some of which may be discussed herein.

### BRIEF SUMMARY OF THE INVENTION

The following portion of this disclosure presents a simplified summary of one or more innovations, embodiments, and/or examples found within this disclosure for at least the purpose of providing a basic understanding of the subject matter. This summary does not attempt to provide an extensive overview of any particular embodiment or example. Additionally, this summary is not intended to identify key/critical elements of an embodiment or example or to delineate the scope of the subject matter of this disclosure. Accordingly, one purpose of this summary may be to present some Innovations, embodiments, and/or examples found within this disclosure in a simplified form as a prelude to a more detailed description presented later.

In various embodiments, methods and systems are provided for interactive user experiences in which the presentation of content from one source can be readily be synchronized with the presentation of additional or supplemental content item the same of different sources in a noninvasive and accurate manner. For example, target content may be associated with additional or supplemental content. The target content may include one or more digital signals, one or more data signals, multimedia information (such as video, audio, images, text, or the like), software applications or games, coupons, advertisements, trivia, web content, or the like, or combinations thereof. The presentation of the target content may occur using a television, a personal computer, a portable media device, or the like. The target content may be delivered to such devices using a variety of known distribution mechanisms, such as a broadcast or transmission medium, physical media, Internet delivery, or the like. The additional or supplemental content may also one or more digital signals, one or more data signals, multimedia information (such as video, audio, images, text, or the like), software applications or games, coupons, advertisements, trivia, web content, or the like, or combinations thereof.

A device, in various embodiments, determines when to present the additional or supplemental content to a user receiving the target content by monitoring the presentation of the target content on the same device or on a different device. A noninvasive accurate synchronization is made between presentation of the target content on one device and presentation of the additional or supplemental content on the same device or another device. Accordingly, the target content may be developed and distributed without the need for additional processing to insert cues, events, or watermarks indicative of a sync signal needed by other devices to remain in sync.

For example, an application, running on device A, may need to be perfectly synchronized with the audio reproduced by a device B. The application running on device A may not have any way to ask to device B what is the current time code of the audio. According to some embodiments, device A may monitor or listen to the audio of device B and obtain, the time code by processing the recorded audio. The application then may, for example, display trivia and/or other information exactly at certain points of a show reproduced by a TV set located in the same room. In further embodiments, additional or supplemental information or content may he presented to users on one device allowing them to know more about items, such as people, places, and things in a movie, TV show, music video. Image, or song, played back on the same or device another device.

A further understanding of the nature of and equivalents to the subject matter of this disclosure (as well as any inherent or express advantages and improvements provided) should be realized in addition to the above section by reference to the remaining portions of this disclosure, any accompanying drawings, and the claims.

### BRIEF DESCRIPTION OF THE DRAWINGS

In order to reasonably describe and illustrate those innovations, embodiments, and/or examples found within this disclosure, reference may be made to one or more accompanying drawings. The additional details or examples used to describe the one or more accompanying drawings should not be considered as limitations to the scope of any of the claimed inventions. any of the presently described embodiments and/or examples, or the presently understood best mode of any innovations presented within this disclosure.

FIG. 1 is a simplified illustration of a platform for smart content tagging and interaction in one embodiment according to the present invention.

FIG. 2 is a flowchart of a method for providing noninvasive multimedia synchronization in one embodiment according to the present invention.

FIG. 3 is a flowchart of a method for providing noninvasive multimedia synchronization to a target signal that is presented at a know time and duration in one embodiment according to the present invention.

FIG. 4 is a flowchart, of a method for providing noninvasive multimedia synchronization using fingerprinting associated with a reference signal in one embodiment according to the present invention.

FIGS. 5A and 5B are a flowchart of a method for providing noninvasive multimedia synchronization of insertion information in one embodiment according to the present invention.

FIGS. 6A and 6B are illustrations of how a user may interact with content in various embodiments according to the present invention.

FIG. 7 illustrates an example of user interface associated with a computing device when the computing device is used as a companion device in the platform of FIG. 1 in one embodiment according to the present invention.

FIG. 8 illustrates an example of a computing device user interface when the computing device is being synched to a particular piece of content being consumed by a user in one embodiment according to the present invention,

FIG. 9 illustrates an example of a computing device user interface showing details of a particular piece of content in one embodiment according to the present invention.

FIG. 10 illustrates an example of a computing device user interface once a computing device is synched to a particular piece of content and has captured a scene in one embodiment according to the present invention.

FIG. 11 illustrates an example of a computing device user interface when a user has selected a piece of interactive content in a synched scene of the piece of content in one embodiment according to the present invention.

FIG. 12 illustrates multiple users each independently interacting with content using the platform of FIG. 1 in one embodiment according to the present invention.

FIG. 13 is a simplified illustration of a system that may incorporate an embodiment of the present invention.

FIG. 14 is a block diagram of a computer system or information processing device that may incorporate an embodiment, be incorporated into an embodiment, or be used to practice any of the innovations, embodiments, and/or examples found within this disclosure.

### DETAILED DESCRIPTION OF THE INVENTION

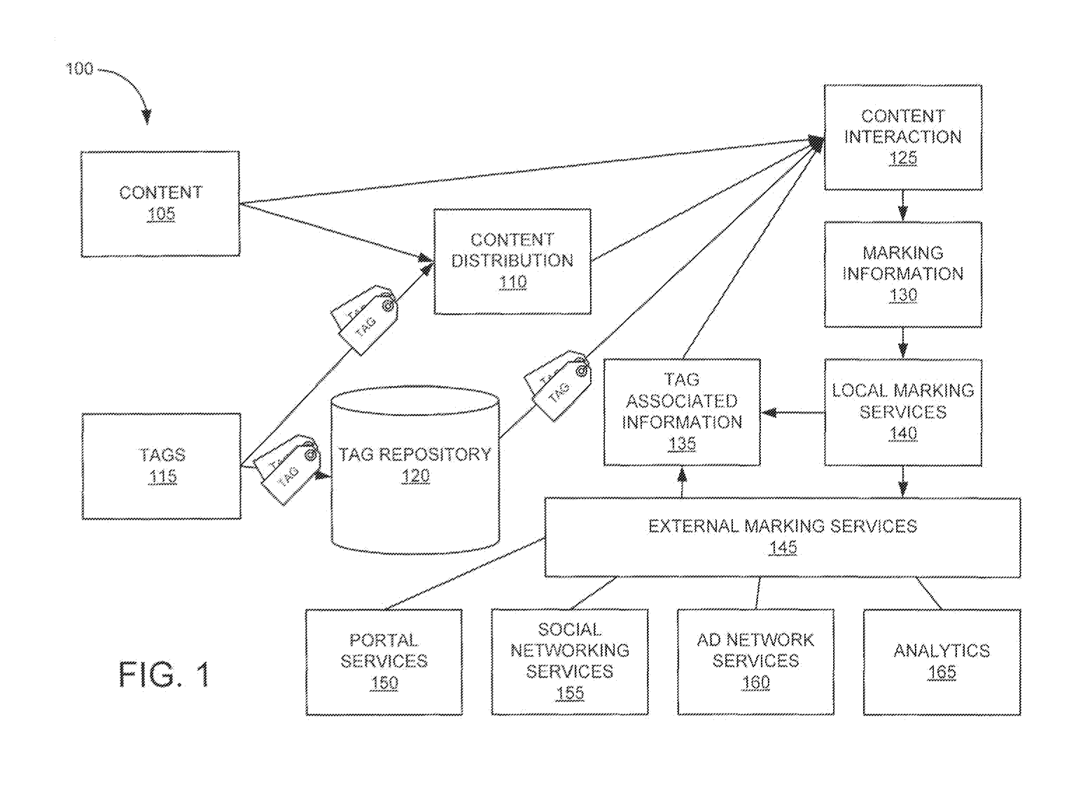

One or more solutions to providing rich content information along with non-invasive interaction can be described using FIG. 1. The following paragraphs describe the figure in details. FIG. 1 may merely be illustrative of an embodiment or implementation of an invention disclosed herein should not limit the scope of any invention as recited in the claims. One of ordinary skill in the art may recognize through this disclosure and the teachings presented herein other variations, modifications, and/or alternatives to those embodiments or implementations illustrated in the figures.

Ecosystem for Smart Content Tagging and Interaction

FIG. 1 is a simplified illustration of platform 100 for smart content tagging and interaction in one embodiment according to the present invention. In this example, platform 100 includes access to content 105, Content 105 may include textual information, audio information. Image information, video information, content metadata, computer programs or logic, or combinations of textual information, audio information, image information, video information, and computer programs or logic, or the like. Content 105 may take the form of movies, music videos, TV shows, documentaries, music, audio books, images, photos, computer games, software, advertisements, digital signage, virtual or augmented reality, sporting events, theatrical showings, live concerts, or the like.

Content 105 may he professionally created and/or authored. For example, content 105 may be developed and created by one or more movie studios, television studios, recording studios, animation houses, or the like. Portions of content 105 may further be created or develops by additional third parties, such as visual effect studios, sound stages, restoration houses, documentary developers, or the like. Furthermore, all or part of content 105 may be user-generated. Content 105 further may be authored using or formatted according to one or more standards for authoring, encoding, and/or distributing content, such as the DVD format, Blu-ray format HD-DVD format H.264, IMAX, or the like.

In one aspect of supporting non-invasive interaction of content 105, platform 100 can provide one or more processes or tools for tagging content 105. Tagging content 105 may involve the identification of all or part of content 105 or objects represented in content 105. Creating and associating tags 115 with content 105 may be referred to as metalogging. Tags 115 can include information and/or metadata associated with all or a portion of content 103. Tags 115 may include numbers, letters, symbols, textual information, audio information, image information, video information, or other multimedia information, or a audio/visual/sensory representation of the like, software, games, or other digital items. Objects represented in content 105 may include people, places, phrases, stems, locations, services, sounds, or the like.

In one embodiment, each of tags 115 can be expressed as a non-hierarchical keyword or term. For example, at least one of tags 115 may refer to a spot in a video where the spot in the video could be a piece of wardrobe. In another: example, at least one of tags 115 may refer to information that a pair of from Levi's 501 blue-jeans is present in the video, Tag metadata may describe an object represented in content 105 and allow it to be found again, by browsing or searching.

In some embodiments, content 105 may be initially tagged by the same professional group that created content 105 (e.g., when dealing with premium content created by Hollywood movie studios). Content 105 may be tagged prior to distribution to consumers or subsequent to distribution to consumers. One or more types of tagging tools can be developed and provided to professional content creators to provide accurate and easy ways to tag content. In further embodiments, content 105 can be tagged by 3rd parties, whether affiliated with the creator of content 105 or not. For example, studios may outsource the tagging of content to contractors or other organisations and companies. In another example, a purchaser or end-user of content 105 may create and associate tags with content 105. Purchases or end-users of content 105 that may tag content 105 may be home users, members of social networking sites, members of fan communities, bloggers, members of the press, or the like.

Tags 115 associated with content 105 can be added, activated, deactivated, and/or removed at will. For example, tags 115 can be added to content 105 after content 105 has been delivered to consumers. In another example, tags 115 can be turned on (activated) or turned off (deactivated) based on user settings, content producer requirements, regional restrictions or locale settings, location, cultural preferences, age restrictions, or the like. In. yet another example, tags 115 can be turned on (activated) or turned off (deactivated) based on business criteria, such as whether a subscriber has paid for access to tags 115, whether a predetermined time period has expired, whether an advertiser decides to discontinue sponsorship of a tag, or the like.

Referring again to FIG. 1, in another aspect of supporting non-invasive interaction of content 105, platform 100 can include content distribution 110. Content distribution 110 can include or refer to any mechanism, services, or technology for distributing content 105 to one or more users. For example, content distribution 110 may include the authoring of content 105 to one or more optical discs, such as CDs, DVDs, HD-DVDs, Blu-ray Disc, or the like. In another example, content distribution 110 may include the broadcasting of content 105, such as through wired/wireless terrestrial radio/TV signals, satellite radio/TV signals, WIFI/WIMAX, cellular distribution, or the like. In yet another example, content distribution 110 may include the streaming or on-demand delivery of content 105, such as through the Internet, cellular networks, IPTV, cable and satellite networks, or the like.

In various embodiments, content distribution 110 may include the delivery of tags 115. In other embodiments, content 105 and tags 115 may be delivered to users separately. For example, platform 100 may include tag repository 120. Tag repository 120 can include one or more databases or information storage devices configured to store tags 115. In various embodiments, tag repository 120 can include one or more databases or information storage devices configured to store information associated with tags 115 (e.g., tag associated information). In further embodiments, tag repository 120 can include one or more databases or information storage devices configured to links or relationships between tags 115 and tag associated information (TAI). Tag repository 120 may be accessible to creators or provides of content 105, creators or providers of tags 115, and to ends users of content 105 and tags 115.

In various embodiments, tag repository 120 may operation as a cache of links between tags and tag associated information supporting content interaction 125.

Referring again to FIG. 1, in another aspect of supporting non-invasive interaction of content 105, platform 100 can include content interaction 125. Content interaction 125 can include any mechanism, services, or technology enabling one or more users to consume content 105 and interact with tags 115. For example, content interaction 125 can include various hardware and/or software elements, such as content playback devices or content receiving devices, such as those supporting embodiments of content distribution 110. For example, a user or group of consumers may consume content 105 using a Bin-ray disc player and interact with tags 115 using a corresponding remote control or using a companion device, such as a dedicated device, smartphone, IPHONE, tablet, IPAD, IPOD TOUCH, or the like.

In another example, a user or group of consumers may consume content 105 using an Internet-enabled set top box and interact with tags 115 using a corresponding remote control or using a companion device, such as a dedicated device, smartphone, IPHONE, tablet, IPAD, IPOD TOUCH, or the like.

In yet another example, a user or group of consumers may consume content 105 at a movie theater or live concert and interact with tags 115 using a companion device, such as a dedicated device, smartphone, IPHONE, tablet, IPAD, IPOD TOUCH, or the like.

In various embodiments, content interaction 125 may provide a user with one or more aural and/or visual representation or other sensory input indicating presences of a tagged item or object represented within content 105. For example, highlighting or other visual emphasis may be used on, over, near, or about all or a portion of content 105 to indicate that something in content 105, such as a person, location, product or item, scene of a feature film, etc. has been tagged. In another example, images, thumbnails, or icons may be used to indicate that something in content 105, such as an item in a scene, has been tagged, therefore, it could be searched.

In one example, a single icon or other visual representation popping up on a display device may provide an indication that something is selectable in the scene. In another example, several icons may pop up on a display device in an area outside of displayed content for each selectable element. In yet another example, an overlay may be provided on top of content 105. In a further example, a list or listing of items may be provided in an area outside of displayed content. In yet a further example, nothing may be represented to the user at all while everything in content 105 is selectable. The user may be informed that something in content 105 has been tagged through one or more different, optional, or other means. These means may be configured via user preferences or other device settings.

In further embodiments, content interaction 125 may not provide any sensory indication that tagged items are available. For example, while tagged items may not be displayed on a screen or display device as active links, hot spots, or action points, metadata associated with each scene can. contain information indicating that tagged items are available. These tags may be referred to as transparent tagged items (e.g., they are presented but not necessarily seen). Transparent tags may be activated via a companion device, smartphone, IPAD, etc. and the tagged items could be stored locally where media is being played or could be stored on one or more external devices, such as a server.

The methodology of content interaction 125 for tagging and interacting with content 105 can be applicable to a variety of types of content 105, such as still images as well as moving pictures regardless of resolution (mobile, standard definition video or HDTV video) or viewing angle. Furthermore, tags 115 and content interaction 125 are equally applicable to standard viewing platforms, live shows or concerts, theater venues, as well as multi-view (3D or stereoscopic) content in mobile, SD, HDTV, IMAX, and beyond resolution,

Content interaction 125 may allow a user to mark items of interest, in content 105. Items of interest to a user may be marked, selected, or otherwise designated as being of interest. As discussed above, a user may interact with content 105 using a variety of input means, such as keyboards, pointing devices, touch screens, remote controls, etc., to mark, select or otherwise indicate one or more items of interest in content 105. A user may navigate around lagged Items on a screen. For example, content Interaction 125 may provide one or more user interfaces that enable, such as with a remote control, L, R, Up, Down options or designations to select tagged items. In another example, content interaction 125 may enable tagged; items to be selected on. a companion, device, such as by showing a captured scene and any items of interest, and using the same tagged item scenes.

As a result of content interaction 125, marking information 130 is generated. Marking information 130 can include information identifying one or more items marks or otherwise identified by a user to be of interest. Marking information 130 may include one or more marks. Marks can be stored locally on a user's device and/or sent to one or more external devices, such as a Marking Server.

During one experience of interacting with content 105, such as watching a movie or listening to a song, a user may mark or otherwise select items or other elements within content 105 which are of interest. Content 105 may be paused or frozen at its current location of playback, or otherwise halted during the marking process. After the process of marking one or more items or elements in content 105, a user can immediately return to the normal experience of interacting with content 105, such as un-pausing a movie from the location at which the marking process occurred.

Referring again to FIG. 1. in another aspect of supporting non-invasive interaction of content 105, platform 100 can include the delivery of tag associated information (TAI) 135 for tags 115. TAI 135 can include information, further content and/or one or more actions. For example, if a user desires further, information about an item, person, or place, the user can mark the item, person, or place, and TAI 135 corresponding to the tag for the marked item, person, or place can be presented. In another example, TAI 135 corresponding to the tag for the marked item, person, or place can be presented with allows the user to perform one or more actions, such as purchase the item, content or email the person, or book travel to the place of interest.

In some embodiments, TAI 135 is statically linked to tags 115. For example, the information, content, and/or one or more actions associated a tag does not expire, change, or is not otherwise modified during the life of content 115 or the tag. In further embodiments, TAI 135 is dynamically linked to tags 115. For example, platform 100 may include one or more computer systems configured to search and/or query one or more offline database, online database or information, sources, 3^{rd} party information source, or the like for information to be associated with a tag. Search results from these one or more queries may be used to generate TAI 135. In one aspect, during various points of the lifecycle of a tag, business rules are applied to search results (e.g., obtained from one or more manual or automated queries) to determine how to associate information, content, or one or more action with a tag. These business rules may be managed by operators of platform 100, content providers, marketing departments, advertisers, creators of user-generated content, fan communities, or the like.

As discussed above, in some embodiments, tags 115 can be added, activated, deactivated, and/or removed at will. Accordingly, in some embodiments, TAI 135 can be dynamically added to, activated, deactivated, or removed from tags 115. For example, TAI 135 associated with tags 115 may change or be updated alter content 105 has been delivered to consumers. In another example, TAI 115 can be turned on (activated) or turned off (deactivated) based on availability of an information source, availability of resources to complete one or more associated actions, subscription expirations, sponsorships ending, or the like.

In various embodiments, TAI 135 can be provided by local marking services 140 or external marking services 145. Local marking services 140 can include hardware and/or software elements under the user's control, such as the content playback device with which the user consumes content 105. In one embodiment, local marking services 140 provide only TAI 135 that has been delivered along with content 105. In another embodiment, local marking services 140 may provide TAI 135 that has been explicitly downloaded or selected by a user. In further embodiments, local marking services 140 may be configured to retrieve TAI 135 from one or more servers associated with platform 100 and cache TAI 135 tor future reference.

In various embodiments, external marking services 145 may be provided by one or more 3rd parties tor the delivery and handling of TAI 135. External marking services 145 may be accessible to a user's content playback device via a communications network, such as the Internet. External marking services 145 may directly provide TAI 135 and/or provide updates, replacements, or other modifications and changes to TAI 135 provided by local marking services 140.

In various embodiments, a user may gain access to further data and consummate transactions through external marking services 145. For example, a user may interact with portal services 150. At least one portal associated with portal services 150 can be dedicated to movie experience extension allowing a user to continue the movie experience (e.g., get more information) and have shopping opportunities for stems of Interest in the movie. In some embodiments, at least one portal associated with portal services 150 can include a white label portal/web service. This portal can provide white label services to movie studios. The service can be further integrated in their respective websites.

In further embodiments, external marking services 145 may provide communication streams to users. RSS feed, emails, forums, and the like provided by external marking services 145 can provide a user with direct access to other users or communities.

In still further embodiments, external marking services 145 can provide social network information to users. A user can access through widgets existing social networks (information and viral marketing for products and movie). Social network services 155 may enable users to share items represented in content 105 with other users in their networks. Social network services 155 may generate interactivity information that enables the other users with whom the items were shared to view TAI 135 and interact with the content much like the original user. The other users may further be able to add tags and tag associated information.

In various embodiments, external marking services 145 can provide targeted advertisement and product identification. Ad network services 160 can supplement TAI 135 with relevant content value propositions, coupons, or the like.

In further embodiments, analytics 165 provides statistical services and tools. These services and tool can provide additional information on a user behavior and interest. Behavior and trend information provided by analytics 165 pray be used to tailor TAI 135 to a user, enhance social network services 155 and Ad network services 160. Furthermore, behavior and trend information provided by analytics 165 may be used to determine product placement review and future opportunities, content sponsorship programs, incentives, or the like.

Accordingly, while some sources, such as Internet websites can provide information services, they fail to translate well info most content experiences, such as in a living room, experience for television or movie viewing, in one example of operation of platform 100, a user can watch a movie and be provided the ability to mark a specific scene. Later, at the user discretion, the user can dig into the scene to obtain more information about people, places, items, effects, or other content represented in the specific scene. In another example of operation of platform 100, one or more of the scenes the user has marked or otherwise expressed an interest in can be shared among the user s friends on a social network, (e.g., Facebook). In yet another example of operation of platform 100, one or more products or services can be suggested to a user that match the user's interest in an item in a scene, the scene itself a movie, genre, or the like.

Noninvasive Accurate Information Synchronization

In various embodiments, methods and systems are provided for interactive user experiences in which the presentation of content from one source can he readily be synchronized with the presentation of additional or supplemental content from the same of different sources in a noninvasive and accurate manner. For example, target content may be associated with additional or supplemental content. The target content may include one or more digital, signals, one or more data signals, multimedia information (such as video, audio, images, text or the like), software applications or games, coupons, advertisements, trivia, web content, or the like, or combinations thereof. The presentation of the target content may occur using a television, a personal computer, a portable media device, or the like. The target content may be delivered to such devices using a variety of known distribution mechanisms, such as a broadcast or transmission medium, physical media, Internet delivery, or the like. The additional or supplemental content may also one or more digital signals, one or more data signals, multimedia information (such as video, audio, images, text, or the like), software applications or games, coupons, advertisements, trivia, web content, or the like, or combinations thereof.

A device in various embodiments, determines when to present the additional or supplemental content to a user receiving the target content by monitoring the presentation of the target content on the same device or on a different device. A noninvasive accurate synchronization is made between presentation of the target content on one device and presentation of the additional or supplemental content on the same device or another device. Accordingly, the target content may be developed and distributed without the need for additional processing to insert cues, events, or watermarks indicative of a sync signal needed by other devices to remain in sync.

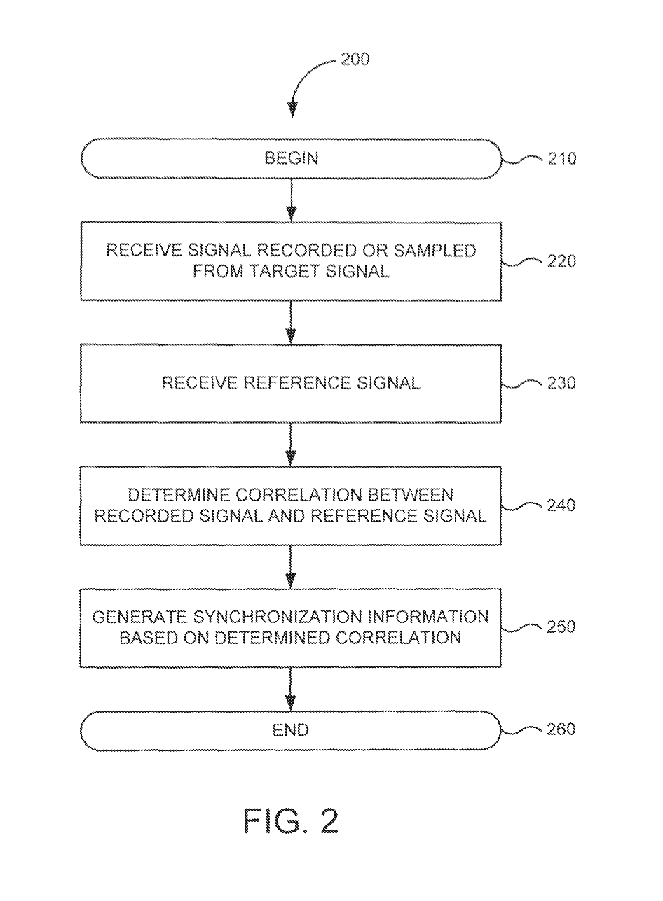

FIG. 2 is a flowchart of method 200 for providing noninvasive multimedia synchronization in one embodiment according to the present invention, implementations of or processing in method 200 depicted in FIG. 2 may be performed by software (e.g., instructions or code modules) when executed by a central processing unit (CPU or processor) of a logic machine, such as a computer system or information processing device, by hardware components of an electronic device or application-specific integrated circuits, or by combinations of software and hardware elements. Method 200 depicted in FIG. 2 begins in step 210.

In step 220, a signal is received that has been recorded or sampled from target signal. A signal is any electrical quantity or effect that can be varied to convey information. A signal may include a time-based presentation of information. The received signal that has been recorded or sampled from target signal may be generated on a device presenting the target signal, on one or more different devices, or combinations thereof in one example, an application running on device A (not shown) may record audio reproduced by device B (not shown). Other well know techniques may be used to record or sample other types of signals, analog or digital that convey specific types of information, such as text, video, images, etc. being played back or transmitted by device B.

In step 230, a reference signal is received. In some embodiments, the reference signal is obtained in one or more ways. For example, the reference signal may be embedded in or with the application running on device A. In another example, the reference signal may be available on some media readable by the application, in yet another example, the reference signal may he obtained through a broadcast transmission or a communications network. The reference signal may be received on a device presenting the target signal, on one or more different devices such as a client device or a. remote server, or combinations thereof.

In step 240, a correlation between the recorded signal and the reference signal is determined. In one example, a correlation can be readily be made between a target signal broadcasted or played back at a specific known time and duration and when the recorded signal is recorded or sampled, In another example, a correlation can be made between a target signal broadcasted or played back at a specific known time but the time or duration of additional content (e.g., insertions) within the target signal is unknown or variable for different channels, regions or time zones. In yet another example, a correlation can be made between a target signal that can jump backward and forward (e.g., content streamed on demand, time shifted, or recording).

In further embodiments, recording or sampling parameters may be adjusted such that the recorded signal is efficiently stored, transmitted, and matched with the reference signal. In much the same way, encoding parameters of the reference information may be accordingly chosen to minimize the bandwidth required for downloading, processing, and maximize the probability for the matching to be successful. Also, the duration of the recording and reference window may be chosen taking into account several factors like: network latency and bandwidth, decoding time, hardware architecture of the device, size of both persistent and volatile memory, fingerprint uniqueness, etc.

In some embodiments, the recorded signal or the reference signal might be filtered and pre/post-processed to increase accuracy and resiliency to noise. In one example, the computation of the correlation is optimized by employing the fast correlation algorithm which makes use of the transformed signals in the frequency domain. This can leverage the highly optimized FFT implementation available in native form on most smart devices,

In one embodiment, detection of the time delay between the reference and the recorded signal is obtained through the following steps:

1. Identification of peaks in the correlation function (for instance by finding the max values in fixed ranges of time).

2. Comparison of peaks with highest values to validate the result (for instance by verifying that the highest peak is greater than the second one by a specific factor).

In step 250, synchronization information is generated based on the determined correlation. Thus, an application, running on device A, may be perfectly synchronized with multimedia information reproduced by a device B even though the application doesn't have any way to ask to device B what is the current time code of the multimedia information. Device A can record or otherwise sample the multimedia information reproduced by device B and obtaining the timecode by processing the recorded information. As an example, an application can display information, trivia, or advertisements exactly at certain points of a show reproduced by a TV set located in the same room, FIG. 2 ends in step 260.

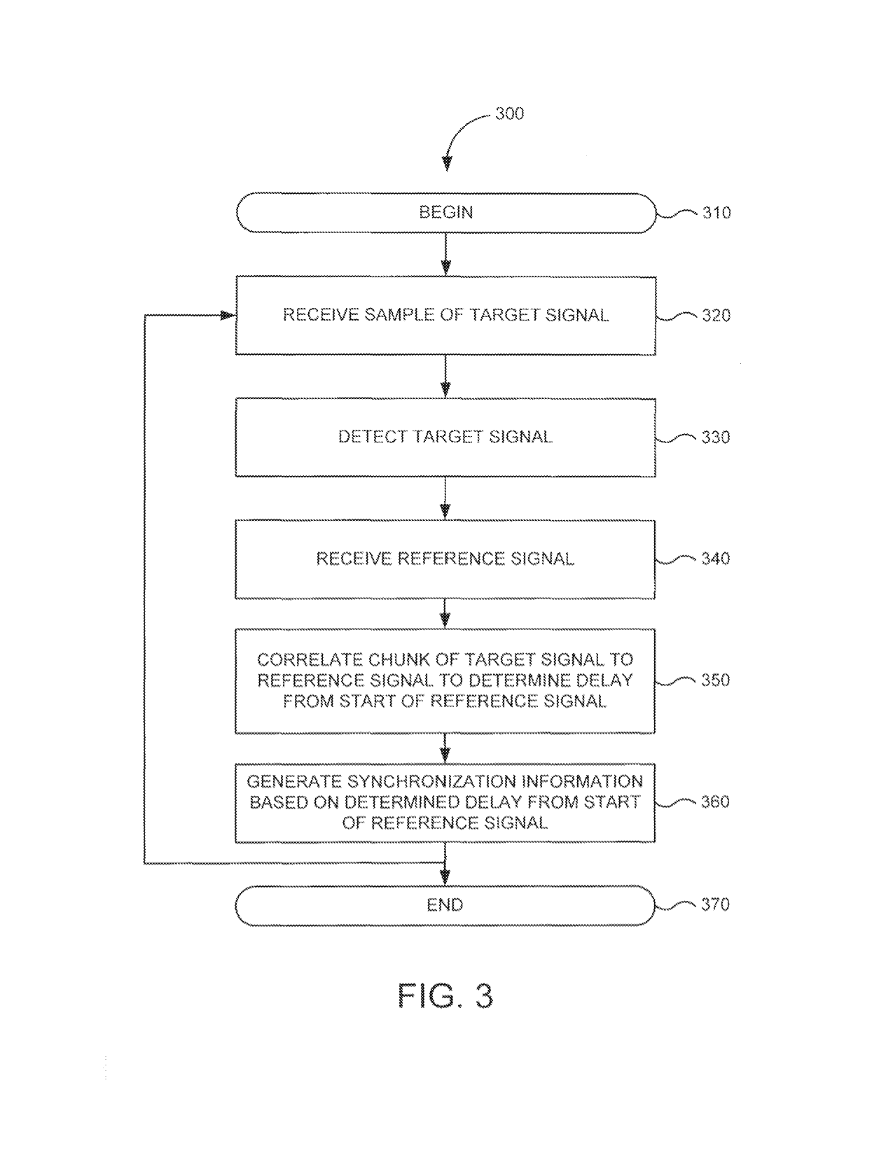

FIG. 3 is a flowchart of method 300 for providing noninvasive multimedia synchronization to a target signal that is presented at a know time and duration in one embodiment according to the present invention. Implementations of or processing in method 300 depicted in FIG. 3 may be performed by software (e.g., instructions or code modules) when executed by a central processing unit (CPU or processor) of a logic machine, such as a computer system or information processing device, by hardware components of an electronic device or application-specific integrated circuits, or by combinations of software and hardware elements. Method 300 depicted in FIG. 3 begins in step 310.

In step 320, a signal is received that has been recorded or sampled from a target signal. In step 330, the target signal is detected. The target signal can be detected in one or more ways. For example, an application receding or sampling a target signal may be bound to a unique piece of content. In another example, an application receding or sampling a target signal may be bound to a predetermined set of content but one or more selection or search criteria, such as time and geo location, are enough to restrict the application to choosing one piece of content. In yet another example, an application receding or sampling a target signal may allow to a user of device A to select a piece of content. In a still further example, an application receding or sampling a target signal may automatically detect what is the target signal (e.g. through fingerprinting as discussed further below).

In step 340, a reference signal is received. In step 350, a chunk of the target signal and a chunk of the reference signal are correlated to determine a delay from the start of the reference signal, in various embodiments, a rough estimate T_{START} of the time at which the target signal is being broadcast or played back is available. Device B presents a delay D relative to T_{START}. Ideally D is In order of tens of seconds. For example, the application running on device A may start recording to obtain T_{REC} seconds of recorded audio and, at the same time, starts obtaining a chunk of T_{REF} seconds of reference audio. The chunk represents a time window in which falls the currently estimated time. As soon as both recorded information and reference information are available, the two are correlated in order to identify the delay of the recorded information within the reference time window. Accordingly, this “chunking” is an optimization that avoids to perform the correlation over the whole reference signal. It can be generalized to any case were ref window start time is known. This can be when a target signal is broadcasted and start time is known or because fingerprinting is performed to select the right reference chunk or in whatever situation where a coarse estimation of synch time is known in advance.

In step 360, synchronization information is generated based on the determined correlation. In one example, the synchronization time is compute as:

synch_time=ref_window_start_time+correlation_delay+(current_time−recording_start_time)

In various embodiments, steps 320-360 might be repeated at one or more intervals to adjust the synchronization time, FIG. 3 ends in step 370.

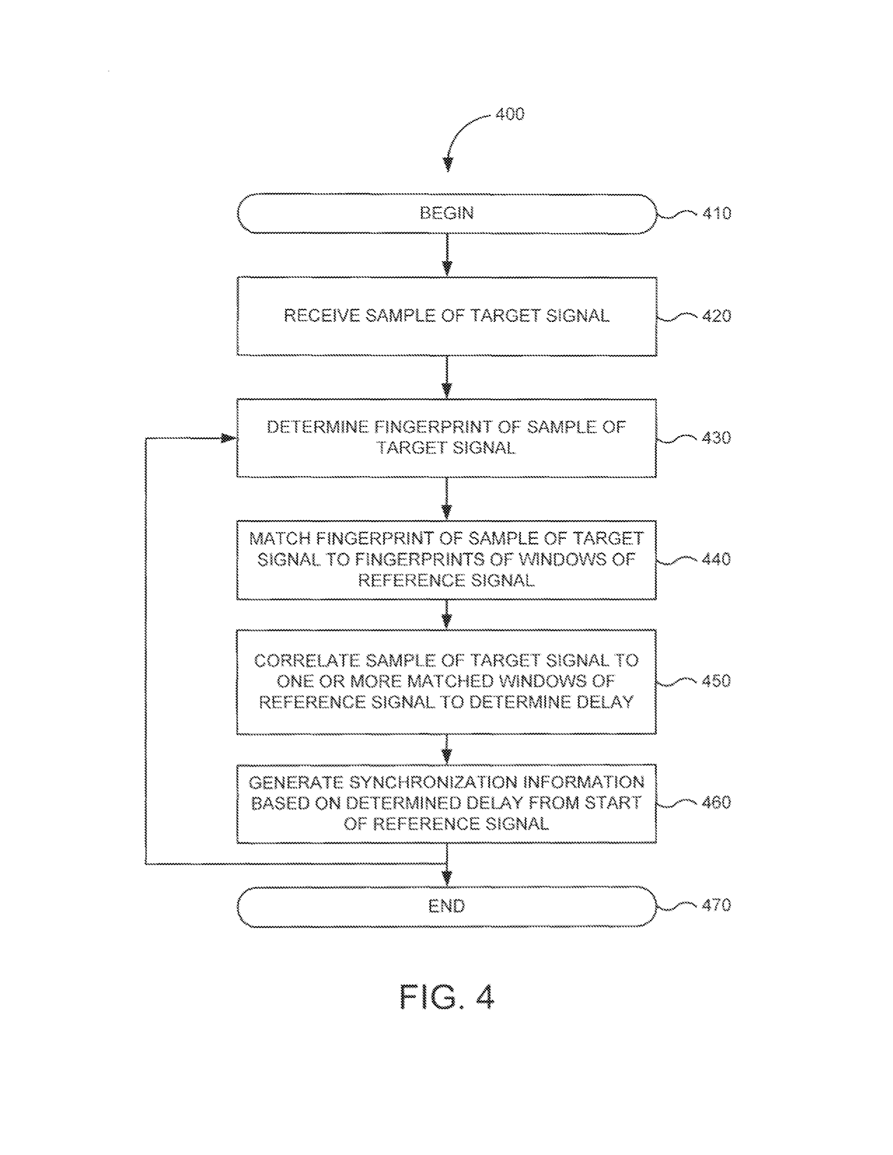

FIG. 4 is a-flowchart, of method 400 for providing noninvasive multimedia synchronization using fingerprinting associated with a reference signal in one embodiment according to the present Invention. Implementations of or processing in method 400 depicted In FIG. 4 may he performed by software (e.g., instructions or code modules) when executed by a central processing unit (CPU or processor) of a logic machine, such as a computer system or information processing device, by hardware components of an electronic device or application-specific integrated circuits, or by combinations of software-and hardware elements. Method 400 depicted in FIG. 4 begins in step 410.

In step 420, a signal is received that has been recorded or sampled from a target signal. In step 430, a fingerprint is determined of the received signal. A fingerprint includes any information that enables a target signal to be uniquely identified. Some examples of fingerprints may include acoustic fingerprints or signatures, video fingerprints, etc. In various embodiments, one or more portions of content are extracted and then compressed to develop characteristic components of the content. The characteristic components may include checksums, hashes, events, watermarks, features, or the like.

In step 440, the fingerprint of the received, signal is matched to fingerprints of windows of a reference signal. For example, in. various embodiments, a reference signal can be pre-analyzed to split it into multiple (optionally overlapping) time windows such that, for each window, a fingerprint is computed. The fingerprint of the sample can be matched against one or more of the fingerprints of the windows of the reference signal to obtain an ordered list of the best matching windows. In various embodiments, the process of matching fingerprints may occur on a device presenting the target signal, one or mote separate and different devices, a remote server, or combinations thereof.

In step 450, the received signal is correlated to one or more matched windows of the reference signal to determine the delay. For example, a device (e.g., the same device presenting the target signal, a different device, a remote server, or combinations thereof) may start obtaining audio reference chunks starting from a best match in the ordered list. As soon as each chunk is available, the signals can he correlated in order to identity the delay of the recorded audio within the reference time window. Thus, in some embodiments, this makes possible to select the right “reference chunk” even when a device suddenly jumps or changes content in the presentation of the target signal.

In step 460, synchronization information is generated based on the determined correlation. In various embodiments, steps 430-460 might be repeated at one or more intervals to adjust the synchronization time. FIG. 4 ends in step 470.

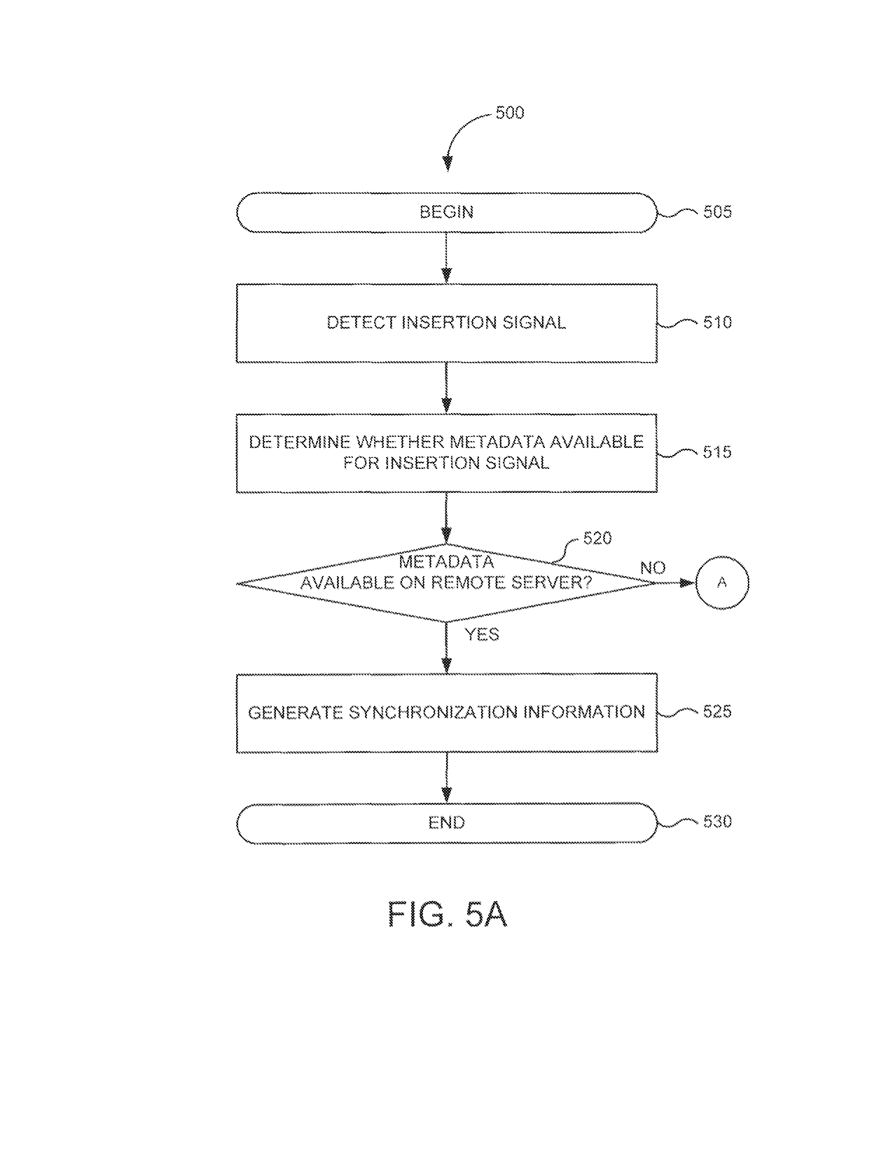

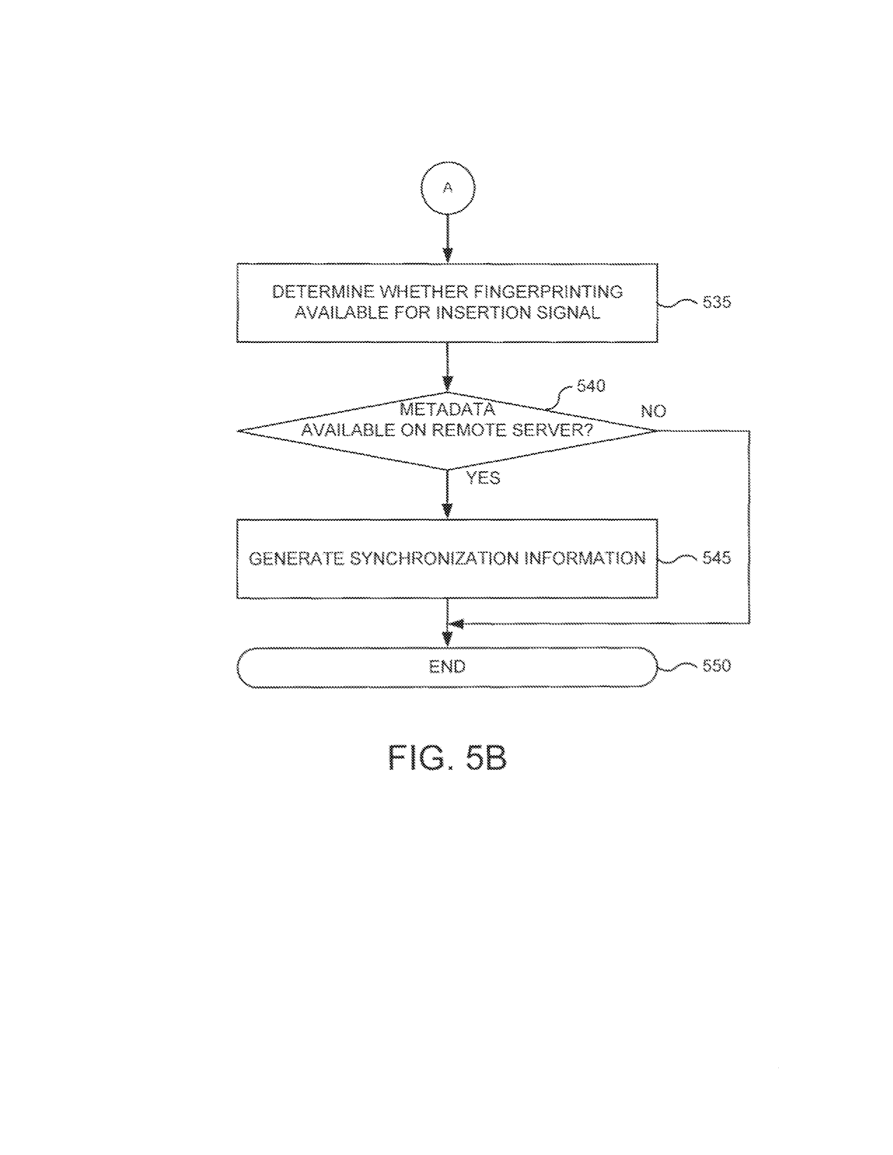

FIGS. 5A and 5B are a flowchart of method 500 for providing noninvasive multimedia synchronization of insertion information in one embodiment according to the present invention. Implementations of or processing in method 500 depicted in FIGS. 5A and 5B may be performed by software (e.g., instructions or code modules) when executed by a central processing unit (CPU or processor) of a logic machine, such as a computer system or information processing device, by hardware components of an electronic device or application-specific integrated circuits, or by combinations of software and hardware elements. Method 500 depicted in FIGS. 5A and 5B begins in step 505.

In step 510, insertion information is detected. For example, target information can contains extraneous content (e.g. advertisements) inserted at certain points. These are refereed to as insertion information (or insertions), insertions can be routed, to tor processing by detecting insertions on the fly or offline and serving such information to the application through a remote server.

In step 515, a determination is made whether metadata is available for the insertion information. In various embodiments, the metadata can be used to compute the timecode in the target timebase from the timecode in the reference timebase. The metadata may be obtained in one of several ways. For example, a qualified human operator may detect insertions and add them to the server. In another example, special equipment is connected to a broadcast of the target information. The special equipment is configured with, lower delay to automatically detect the insertions and add them to the server. Such equipments can be distributed geographically to cover different zones. In yet another example, cloud sourcing may be used as devices already in syne signal their D and loss of sync to the server. This is used by the server to add insertions.

In step 520, if a determination is made that metadata is available for the insertion information, processing continues in step 525 where synchronization information is generated and FIG. 5A ends in step 530.

In step 520, if a determination is made that metadata is not available for the insertion information, processing continues in FIG. 5B at step 535. In step 535, a determination is made whether fingerprinting is available for the insertion information. In step 540, if a determination is made that fingerprinting is available for the insertion information, processing continues in step 545 where synchronization information is generated and FIG. 5B ends in step 550. Otherwise FIG. 5B ends in step 550.

In various embodiments, some optimizations can be put in place to improve matching of insertions. In one example, a remote server can use an estimated broadcast time to statistically improve the precision of the fingerprint matching algorithm. In another example, the server may collect the statistics of the requests related to a particular audio, to adaptively assign different weights to different time windows, so to increase the probability of a correct matching of the fingerprints computed on the recorded audio samples.

It is imagined that the processing described above can take place on a single device, two devices in relative proximity, or moved to one or more remote devices. For example, audio correlation between reference audio and recorded audio can be done on a remote device. This is useful when device A has no the power or the ability to perform such computation. The remote device can be a remote server or any other device that can perform correlation.

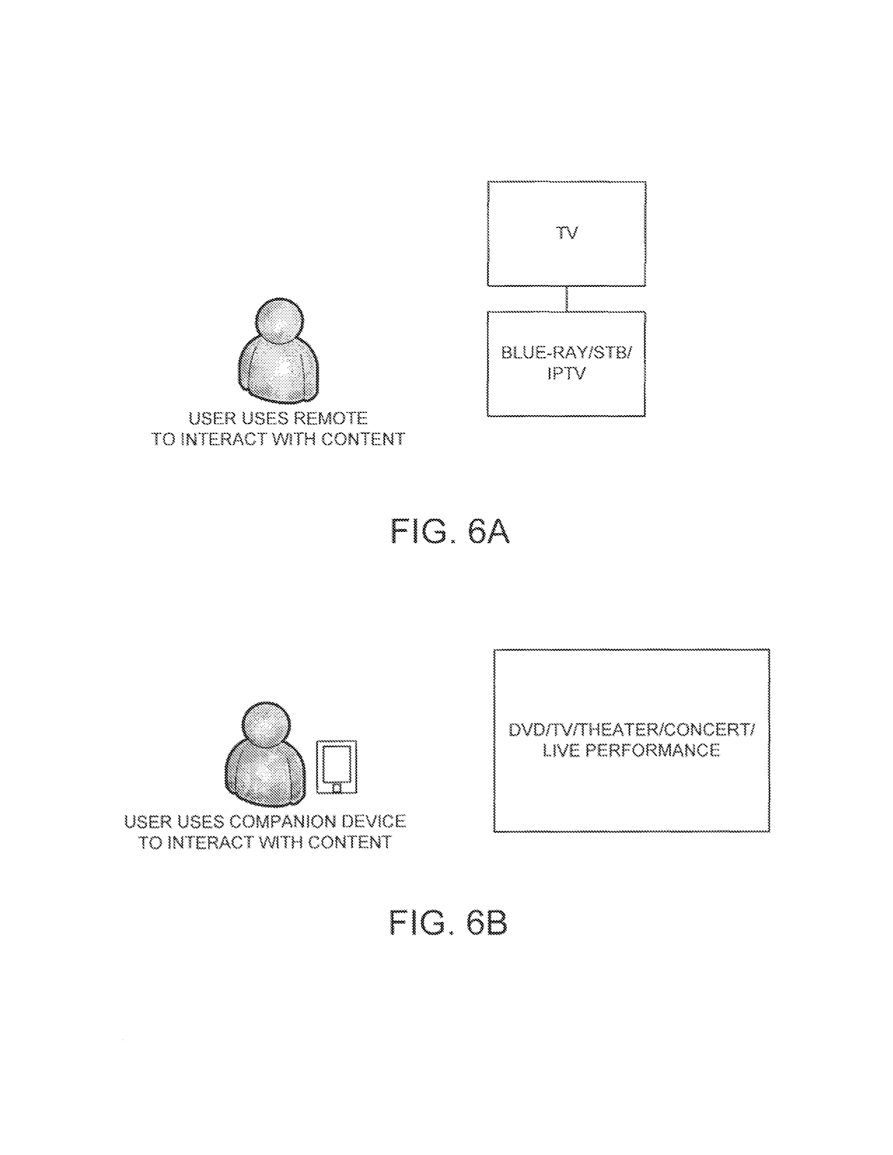

FIGS. 6A and 6B are illustrations of how a user may Interact with content in various embodiments according to the present invention.

Companion Devices

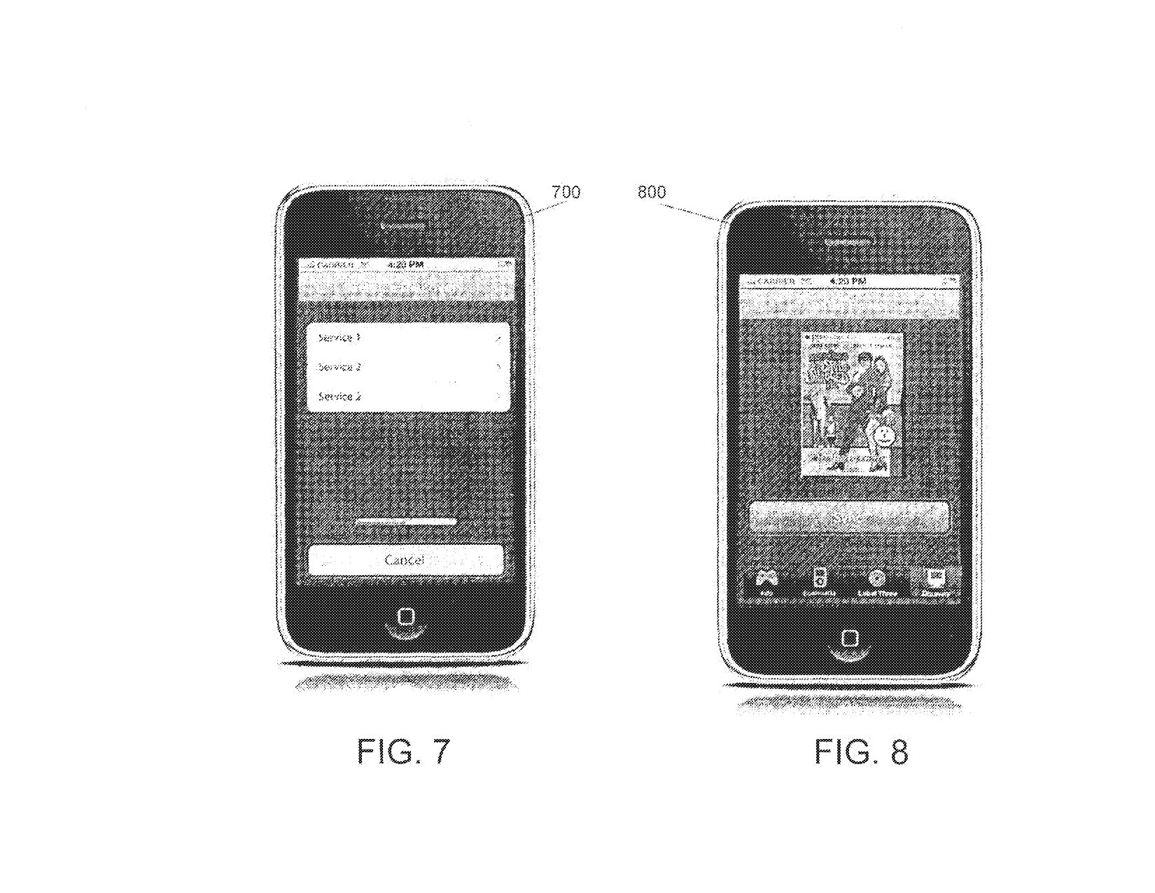

FIG. 7 illustrates an example of a user interface associated with computing device 700 when, computing device 700 is used as a companion device in platform 100 of FIG. 1 in one embodiment according to the present invention. In various embodiments, computing device 700 may automatically detect availability of interactive content and/or a communications link with one or more elements of platform 100. In further embodiments, a user may manually initiate communication between computing device 700 and one or more elements of platform 100. In particular, a user may launch an interactive content application on computing device 700 that sends out a multicast ping to content devices near computing device 700 to establish a connection (wireless or wired) to the content devices for interactivity with platform 100.

FIG. 8 illustrates an example of a computing device user interface when computing device 800 is being synched to a particular piece of content being consumed by a user in one embodiment according to the present invention. The user interface of FIG. 8 shows computing device 800 in the process of establishing a connection, in a multiuser environment having multiple users, platform 100 permits the multiple users to establish a connection to one or more content devices so that each user can have their own, independent interactions with the content.

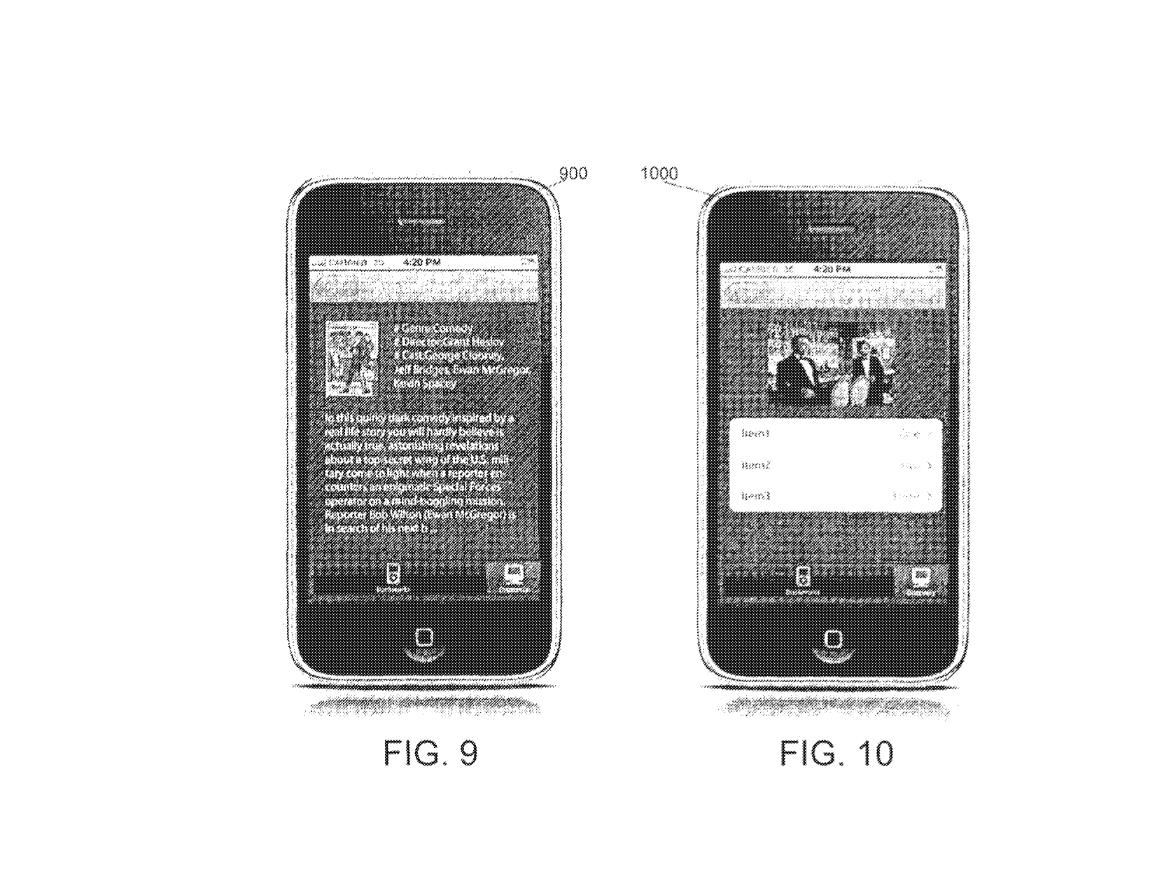

FIG. 9 illustrates an example of a computing device user interface showing details of a particular piece of content in one embodiment according to the present invention. In this example, computing device 900 can be synchronized to a piece of content, such as the movie entitled “Austin Powers.” For example, computing device 900 can be synchronized to the content automatically or by having a user select a sync button from a user interlace. In further embodiments, once computing device 900 has established a connection (e.g., either directly with a content playback device or indirectly through platform 100), computing device 900 is provided with its own independent feed of content. Accordingly, in various embodiments, computing device 900 can capture any portion of the content (e.g., a scene when the content is a movie). In further embodiments, each computing device in a multiuser environment can be provided with its own independent feed of content independent of the other computing devices.

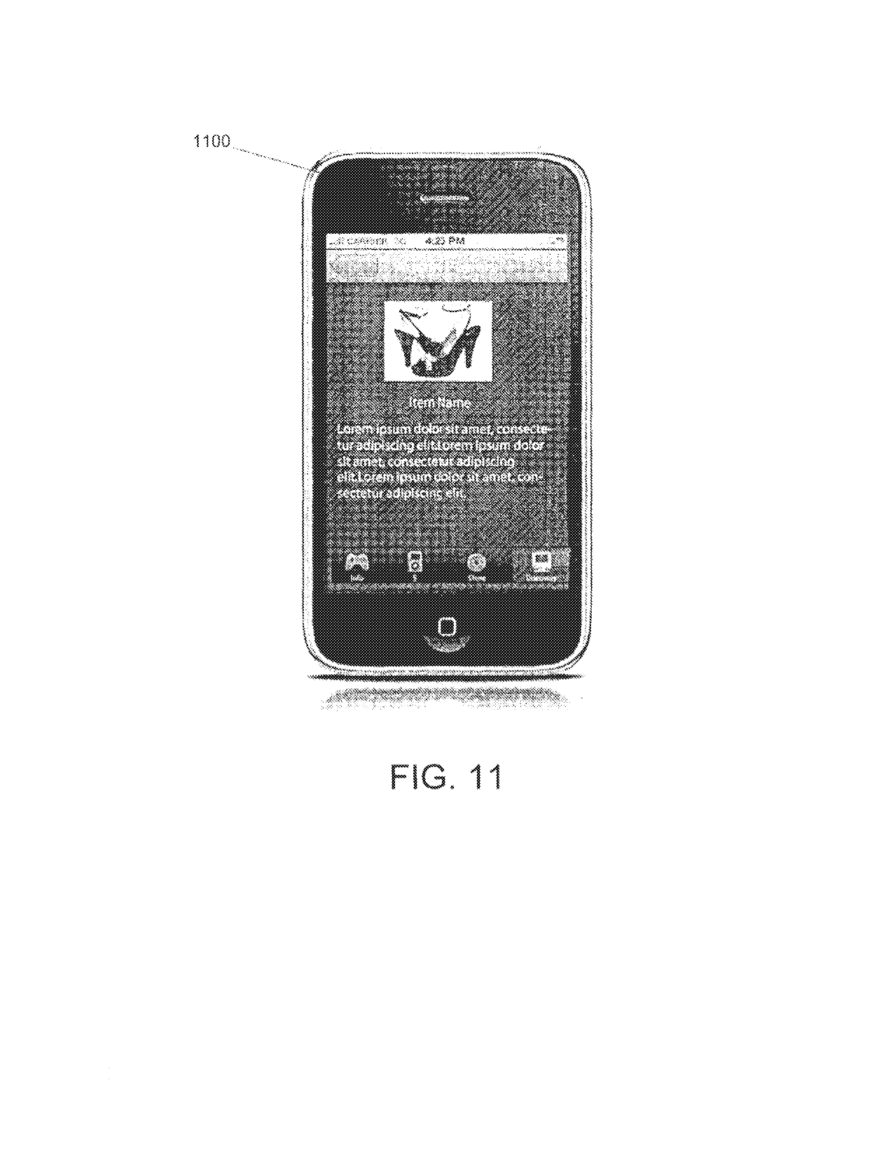

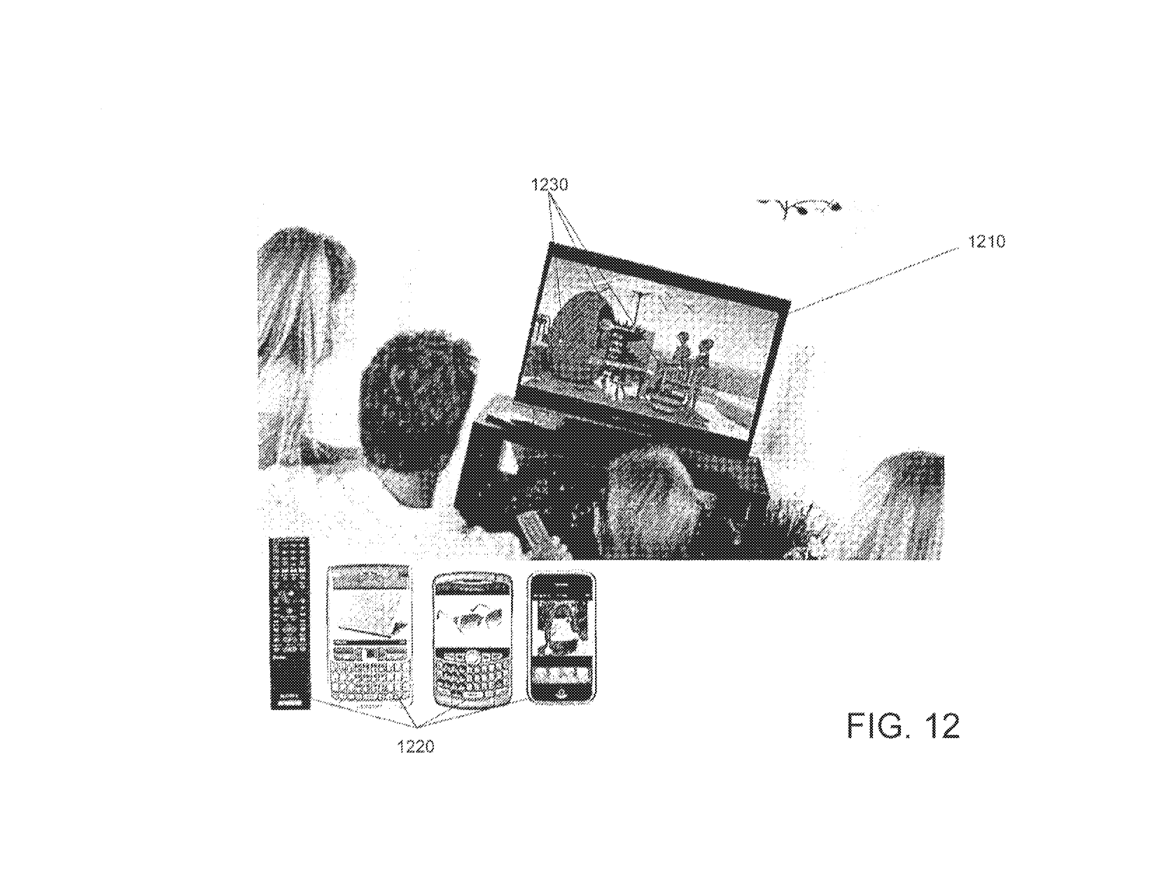

FIG. 10 illustrates an example of a computing device user interface once computing device 1000 is synched to a particular piece of content and has captured a scene in one embodiment according to the present invention. Once computing device 1000 has synched to a scene of the content, a user can perform a variety of interactivity operations (e.g., the same interactivity options discussed above-playitem/play scenes with item; view details; add to shopping list; buy item; see shopping list/cart; see “What's Hot”; and See “What's next” as described above). FIG. 11 illustrates an example of a computing device user interface of computing device 1100 when a user has selected a piece of interactive content In a synched scene of the piece of content in one embodiment according to the present invention.

In various embodiments, a companion or computing device associated with platform 100 may also allow a user to share the scene/items, etc. with another user and/or comment on the piece of content. FIG. 12 illustrates multiple users each independently interacting with content using platform 100 of FIG. 1 in one embodiment according to the present invention. In one example, content device 1210 (e.g., a BD player or set top box and TV) may be displaying a movie and each user is using a particular computing device 1220 to view details of a different product in the scene being displayed wherein each of the products is marked using interactive content landmarks 1230 as described above. As shown in FIG. 12, one user is looking at the details of the laptop, while another user is looking at the glasses or the chair.

Hardware and Software

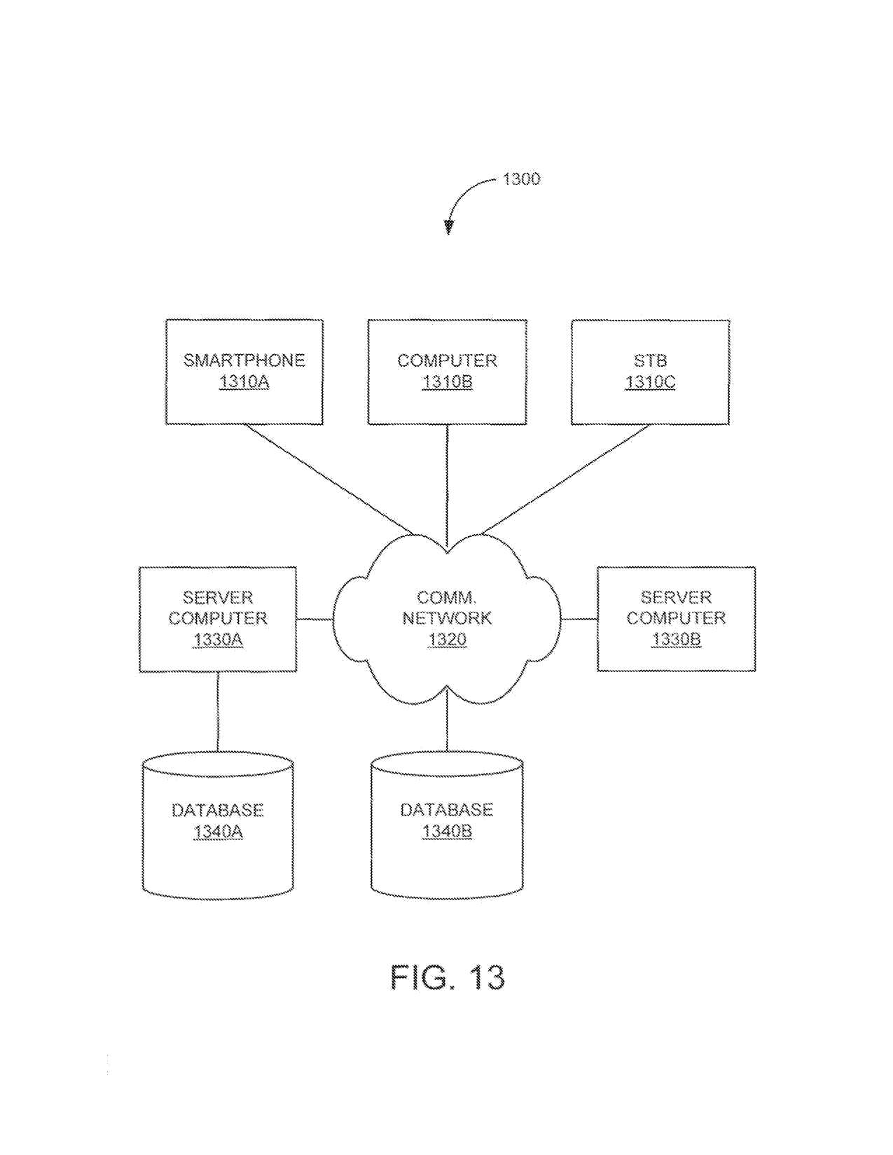

FIG. 13 is a simplified illustration of system 1300 that may incorporate an embodiment or be incorporated into an embodiment of any of the innovations, embodiments, and/or examples found within this disclosure. FIG. 1300 is merely illustrative of an embodiment incorporating the present invention and does not limit the scope of the invention as recited in the claims. One of ordinary skill in the art would recognize other variations, modifications, and alternatives.

In one embodiment, system 1300 Includes one or more user computers or electronic devices 1310 (e.g., smart-phone or companion device 3310A, computer 1310B, and set-top box 1310C). Computers or electronic devices 1310 can be general purpose personal computers (including, merely by way of example, personal computers and/or laptop computers running any appropriate flavor of Microsoft Corp.'s Windows™ and/or Apple Corp's Macintosh™ operating systems) and/or workstation computers running any of a variety of commercially-available UNIX™ or UNIX-like operating systems. Computers or electronic devices 1310 can also have any of a variety of applications, including one or more applications configured to perform methods of the invention, as well as one or more office applications, database client and/or server applications, and web browser applications.

Alternatively, computers or electronic devices 1330 can be any other consumer electronic device, such as a thin-client computer, Internet-enabled mobile telephone, and/or personal digital assistant, capable of communicating via a network (e.g., communications network 1320 described below) and/or displaying and navigating web pages or other types of electronic documents. Although the exemplary system 1300 is shown with three computers or electronic devices 1310, any number of user computers or devices can be supported. Tagging and displaying tagged items can be implemented on consumer electronics devices such as Camera and Camcorder. This could be done via touch screen or moving the cursor and selecting the objects and categorizing them.

Certain embodiments of the invention operate in a networked environment, which can include communications network 1320. Communications network 1320 can be any type of network familiar to those skilled In the art that can support data communications using any of a variety of commercially-available protocols, including without limitation TCP/IP, SNA, IPX, AppleTalk, and the like. Merely by way of example, communications network 1320 can be a local area network (“LAN”) including without limitation an Ethernet network, a Token-Ring network and/or the like; a wide-area network; a virtual network, including without limitation a virtual private network (“VPN”); the Internet; an intranet; an extranet; a public switched telephone network PSTN); an infra-red network; a wireless network, including without limitation a network operating under any of the IEEE 802.11 suite of protocols, WIFI, he Bluetooth™ protocol known in the art, and/or any other wireless protocol; and/or any combination of these and/or other networks.

Embodiments of the invention can include one or more server computers 1330 (e.g., computers 1330A and 1330B), Each of server computers 1330 may be configured with an operating system including without limitation any of those discussed above, as well as any commercially-available server operating systems. Each of server computers 1330 may also be running one or more applications, which can be configured to provide services to one or more clients (e.g., user computers 1310) and/or other servers (e.g., server computers 1330).

Merely by way of example, one of server computers 1330 may be a web server, which can be used, merely by way of example, to process requests for web pages or other electronic documents from user computers 1310. The web server can also run a variety of server applications, including HTTP servers, FTP servers, CGI servers, database servers, Java servers, and the like. In some embodiments of the invention, the web server may be configured to serve web pages that can be operated within a web browser on one or more of the user computers 1310 to perform methods of the invention.

Server computers 1330, in some embodiments, might include one ore more file and or/application servers, which can include one or more applications accessible by a client running on one or more of user computers 1310 and/or other server computers 1330. Merely by way of example, one or more of server computers 1330 can be one or more general purpose computers capable of executing programs or scripts in response to user computers 1310 and/or other server computers 1330, including without limitation web applications (which might, in some cases, be configured to perform methods of the invention).

Merely by way of example, a web application can be implemented as one or more scripts or programs written in any programming language, such as Java, C, or C++, and/or any scripting language, such as Peri Python, or TCL, as well as combinations of any programming/scripting languages. The application server(s) can also include database servers, including without limitation those commercially available from Oracle, Microsoft, IBM and the like, which can process requests from database clients running on one of user computers 1310 and/or another of server computers 1330.

In some embodiments, an application server can create web pages dynamically for displaying the information in accordance with embodiments of the invention. Data provided by an application server may be formatted as web pages (comprising HTML, XML, Javascript, AJAX, etc., tor example) and/or may be forwarded to one of user computers 1310 via a web server (as described above, for example). Similarly, a web server might receive web page requests and/or input data from one of user computers 1310 and/or forward the web page requests and/or input data to an application server.

In accordance with further embodiments, one or more of server computers 1330 can function as a file server and/or can include one or more of the files necessary to implement methods of the invention incorporated by an application running on one of user computers 1310 and/or another of server computers 1330. Alternatively, as those skilled in the art will appreciate, a file server can include all necessary files, allowing such an application to be invoked remotely by one or more of user computers 1310 and/or server computers 1330. It should be noted that the functions described with respect to various servers herein (e.g., application server, database server, web server, file server, etc.) can be performed by a single server and/or a plurality of specialized servers, depending on implementation-specific needs and parameters.

In certain embodiments, system 1300 can include one or more databases 1340 (e.g., databases 1340A and 1340B). The location of the database(s) 1320 is discretionary: merely by way of example, database 1340A might reside on a storage medium local to (and/or resident in) server computer 1330A (and/or one or more of user computers 1310). Alternatively, database 1340B can be remote from any or all of user computers 1310 and server computers 1330, so long as it can be in communication (e.g., via communications network 1320) with one or more of these. In a particular set of embodiments, databases 1340 can reside in a storage-area network (“SAN”) familiar to those skilled in die art. (Likewise, any necessary flies for performing the functions attributed to user computers 1310 and server computers 1330 can be stored locally on the respective computer and/or remotely, as appropriate). In one set of embodiments, one or more of databases 1340 can be a relational database that is adapted to store, update, and retrieve data in response to SQL-formatted commands. Databases 1340 might be controlled and/or maintained by a database server, as described above, for example.

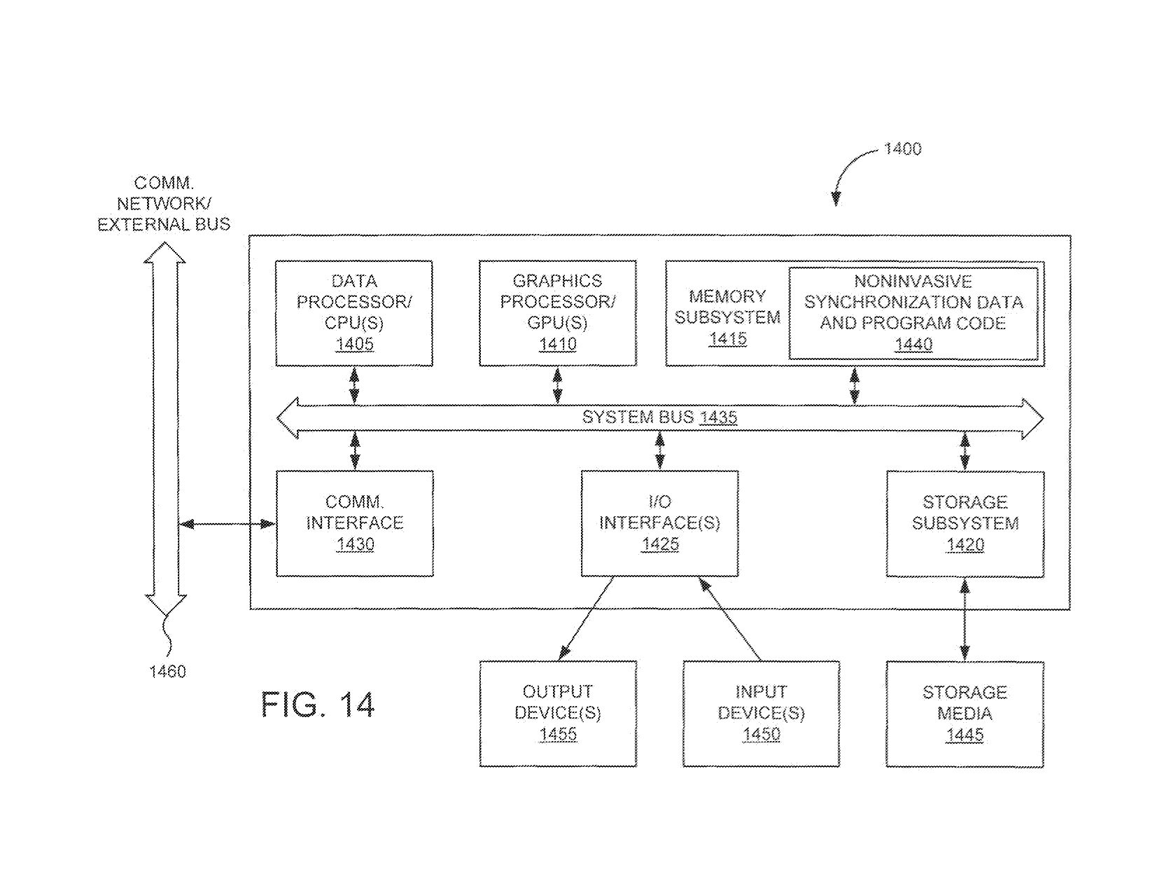

FIG, 14 is a. block diagram of computer system 1400 that may incorporate an embodiment, be incorporated into an embodiment, or be used to practice any of the innovations, embodiments, and/or examples found within this disclosure. FIG. 14 is merely illustrative of a computing device, general-purpose computer system programmed according to one or more disclosed techniques, specific information processing device or consumer electronic device for an embodiment incorporating an invention whose teachings may be presented herein and does not limit the scope of the Invention as recited in the claims. One of ordinary skill in the art would recognize other variations, modifications, and alternatives.

Computer system 1400 can include hardware and/or software elements configured for performing logic operations and calculations, input/output operations, machine communications, or the like. Computer system 1400 may include familiar computer components, such as one or more one or more data processors or central processing units (CPUs) 1405, one or more graphics processors or graphical processing units (GPUs) 1410, memory subsystem 1415, storage subsystem 1420, one or more input/output (I/O) interfaces 1425, communications interface 1430, or the like. Computer system 1400 can include system bus 1435 interconnecting the above components and providing functionality, such connectivity and inter-device communication. Computer system 1400 may be embodied as a computing device, such as a personal computer (PC), a workstation, a mini-computer, a mainframe, a cluster or farm of computing devices, a laptop, a notebook, a netbook, a PDA, a smartphone, a consumer electronic device, a gaming console, or the like.

The one or more data processors or central processing units (CPUs) 1405 can include hardware and/or software elements configured for executing logic or program code or for providing application-specific functionality. Some examples of CPU(s) 1405 can include one or more microprocessors (e.g., single core and multi-core) or micro-controllers. CPUs 1405 may include 4-bit, 8-bit, 12-bit, 8-bit, 32-bit, 64-bit, or the like architectures with similar or divergent internal and external instruction, and data designs. CPUs 1405 may former Include a single core or multiple cores. Commercially available processors may Include those provided by Intel of Santa Clara, Calif. (e.g., x86, x86_{—}64, PENTIUM, CELERON, CORE, CORE 2, CORE ix, ITANIUM, XEON, etc.), by Advanced Micro Devices of Sunnyvale, Calif. (e.g., x86, AMD_{—}64, ATHLON, DURON, TURION, ATHLON XP/64, OPTERON, PHENOM, etc). Commercially available processors may further include those conforming to the Advanced RISC Machine (ARM) architecture (e.g., ARMv7-9), POWER and POWERPC architecture, CELL architecture, and or the like. CPU(s) 1405 may also include one or more field-gate programmable arrays (FPGAs), application-specific integrated circuits (ASICs), or other microcontrollers. The one or more data processors or central processing units (CPUs) 1405 may include any number of registers, logic units, arithmetic units, caches, memory interlaces, or the like. The one or more data processors or central, processing units (CPUs) I40S may further he integrated, irremovably or moveably, Into one or more motherboards or daughter hoards.

The one or more graphics processor or graphical processing units (CPUs) 1410 can include hardware and/or software elements configured for executing logic or program code associated with graphics or for providing graphics-specific functionality. GPUs 1410 may include any conventional graphics processing unit, such as those provided by conventional video cards, Some examples of GPUs are commercially available from NVIDIA, ATI, and other vendors. In various embodiments, GPUs 1410 may include one or more vector or parallel processing units. These GPUs may be user programmable, and include hardware elements for encoding/decoding specific types of data (e.g., video data) or for accelerating operations, or the like. The one or more graphics processors or graphical processing units (GPUs) 1410 may include any number of registers, logic units, arithmetic units, caches, memory interfaces, or the like. The one or more data processors or central processing units (CPUs) 1405 may further be integrated, irremovably or moveably, into one or more motherboards or daughter boards that include dedicated video memories, frame buffers, or the like.

Memory subsystem 1415 can include hardware and/or software elements configured for storing information. Memory subsystem 1415 may store information using machine-readable articles, information storage devices, or computer-readable storage media. Some examples of these articles used by memory subsystem 1470 can include random access memories (RAM), read-only-memories (ROMS), volatile memories, non-volatile memories, and other semiconductor memories. In various embodiments, memory subsystem 1415 can include noninvasive synchronization data and program code 1440.

Storage subsystem. 1420 can include hardware and/or software elements configured for storing information. Storage subsystem 1420 may store information using machine-readable articles, information storage devices, or computer-readable storage media. Storage subsystem 1420 may store information using storage media 1445. Some examples of storage media 1445 used by storage subsystem 1420 can include floppy disks, hard disks, optical storage media such as CD-ROMS, DVDs and bar codes, removable storage devices, networked storage devices., or the like. In some embodiments, all or part of noninvasive synchronization data data and program code 1440 may be stored using storage subsystem 1420.

In various embodiments, computer system 1400 may include one or more hypervisors or operating systems, such as WINDOWS, WINDOWS NT, WINDOWS XP, VISTA, WINDOWS 7 or the like from Microsoft of Redmond, Wash., Mac OS or Mac OS X from. Apple Inc. of Cupertino, Calif., SOLARIS from Sun Microsystems, LINUX, UNIX, and other UNIX-based or UNIX-like operating systems. Computer system 1400 may also include one or more applications configured to execute, perform, or otherwise implement techniques disclosed herein. These applications may be embodied as noninvasive synchronization data and program, code 1440. Additionally, computer programs, executable computer code, human-readable source code, or the like, may be stored in memory subsystem 1415 and/or storage subsystem 1420.

The one or more Input/output (I/O) interfaces 1425 can include hardware and/or software elements configured .for performing I/O operations. Que or more input devices 1450 and/or one or more output devices 1455 may be communicatively coupled to the one or more I/O interfaces 1425.

The one or more input devices 1450 can include hardware and/or software elements configured for receiving information from one or more sources for computer system 1400. Some examples of the one or more input devices 1450 may include a computer mouse, a trackball, a track pad, a joystick, a wireless remote, a drawing tablet, a microphone, a camera, a photosensor, a voice command system, an eye tracking system, external, storage systems, a monitor appropriately configured as a touch screen, a communications interface appropriately configured as a transceiver, or the like. In various embodiments, the one or more input, devices 1450 may allow a user of computer system 1400 to interact with one or more non-graphical or graphical user Interfaces to enter a comment, select objects, icons, text, user interface widgets, or other user interface elements that appear on a monitor/display device via a command, a click of a button, or the like.

The one or more output devices 1455 can include hardware and/or software elements configured for outputting information to one or more destinations for computer system 1400. Some examples of the one or more output devices 1455 can include a printer, a fax, a feedback device for a mouse or joystick, external storage systems, a monitor or other display device, a communications interface appropriately configured as a transceiver, or the like. The one or more output devices 1455 may allow a user of computer system 1400 to view objects, icons, text, user interlace widgets, or other user interface elements.

A display device or monitor may be used with computer system 1400 and can include hardware and/or software elements configured for displaying information. Some examples include familiar display devices, such as a television monitor, a cathode ray tube (CRT), a liquid crystal display (LCD), or the like.

Communications interface 1430 can include hardware and/or software elements configured for performing communications operations, including sending and receiving data. Some examples of communications interface 1430 may include a network communications interface, an external bus interface, an Ethernet card, a modem (telephone, satellite, cable, ISDN), (asynchronous) digital subscriber line (DSL) unit, FireWire interface, USB interface, or the like. For example, communications interface 1430 may be coupled: to communications network/external bus 1480, such as a computer network, to a FireWire bus, a USB hub, or the like. In other embodiments, communications Interface 1430 may be physically integrated as hardware on a motherboard or daughter board of computer system 1400, may be implemented as a software program, or the like, or may be implemented as a combination thereof.

In various embodiments, computer system 1400 may Include software that enables communications over a network, such as a local area network or the Internet, using one or more communications protocols, such as the HTTP, TCP/IP, RTP/RTSP protocols, or the like. In some embodiments, other communications software and/or transfer protocols may also be used, for example IPX, UDP or the like, for communicating with hosts over the network or with a device directly connected to computer system 1400.

As suggested, FIG. 14 is merely representative of a general-purpose computer system appropriately configured or specific data processing device capable of implementing or incorporating various embodiments of an invention presented within this disclosure. Many other hardware and/or software configurations may be apparent to the skilled artisan which are suitable for use in implementing an invention presented within this disclosure or with various embodiments of an invention presented within tins disclosure. For example, a computer system or data processing device may include desktop, portable, rack-mounted, or tablet configurations. Additionally, a computer system or information processing device may include a series of networked computers or clusters/grids of parallel processing devices. In still other embodiments, a computer system or information processing device may perform techniques described above as implemented upon a chip or an auxiliary processing board.

Various embodiments of any of one or more inventions whose teachings may be presented within this disclosure can be implemented in the form of logic in software, firmware, hardware, or a combination thereof. The logic may be stored in or on a machine-accessible memory, a machine-readable article, a tangible computer-readable medium, a computer-readable storage medium, or other computer/machine-readable media as a set of instructions adapted to direct a central processing unit (CPU or processor) of a logic machine to perform a set of steps that may be disclosed in various embodiments of an invention presented within this disclosure. The logic may form part of a software program or computer program product as code modules become operational with a processor of a computer system or an information-processing device when executed to perform a method or process in various embodiments of an invention presented within this disclosure. Based on this disclosure and the teachings provided herein, a person of ordinary skill in the art will appreciate other ways, variations, modifications, alternatives, and/or methods for implementing in software, firmware, hardware, or combinations thereof any of the disclosed operations or functionalities of various embodiments of one or more of the presented inventions.

The disclosed examples, implementations, and various embodiments of any one of those inventions whose teachings may be presented within this disclosure are merely illustrative to convey with reasonable clarity to those skilled in the art the teachings of this disclosure. As these implementations and embodiments may be described with reference to exemplary illustrations or specific figures, various modifications or adaptations of the methods and/or specific structures described can become apparent to those skilled in the art. All such modifications, adaptations, or variations that rely upon this disclosure and these teachings found herein, and through which the teachings have advanced the art, are to be considered within the scope of the one or more inventions whose teachings may be presented within this disclosure. Hence, the present descriptions and drawings should not be considered in a limiting sense, as it is understood that an invention presented within a disclosure is in no way limited to those embodiments specifically illustrated.

Accordingly, the above description and any accompanying drawings, illustrations, and figures are intended to be illustrative but not restrictive. The scope of any invention presented within this disclosure should, therefore, be determined not with simple reference to the above description and those embodiments shown in the figures, but instead should be determined with reference to the pending claims along with their full scope or equivalents.

1. A method for providing an interactive user experience, the method comprising:
receiving, at one or more computer systems, a first signal recorded or sampled from a target signal;
determining, with one or more processors associated with the one or more computer systems, a reference signal based on the first signal;
determining, with the one or more processors associated with the one or more computer systems, a correlation between the first signal and the reference signal; and
generating, with the one or more processors associated with, the one or more computer systems, synchronization information between presentation of the target information and presentation of a second signal.

2. A method for non-invasive accurate audio correlation as described above.

3. A non-transitory computer-readable medium storing processor-executable code for directing a processor to perform non-Invasive accurate audio correlation as described above.

4. A handheld device having at least a microphone, a display, a processor, and a memory wherein the memory is configured to store a set of instructions which direct the processor to capture audio from an audio source using the microphone and synchronize playback of content on the display to playback of audio at the audio source.
